(19) United States
(12) Patent Application Publication
(10) Pub. No.: US 2026/0279085 A1
(43) Pub. Date: Sep. 17, 2026

(54) SYSTEM AND METHOD FOR UNSTRUCTURED DATA AUTOMATION

(71) Applicants: Jonathan David Humpherys, Weatogue, CT (US); Jacqueline E. Teach, Enfield, CT (US); Mark DiPaola, Middletown, CT (US); Emma C. Walker, West Winfield, NY (US); Samuel Asante Buahin, Charlotte, NC (US); Kunal Prakash Chaudhari, Charlotte, NC (US)

(72) Inventors: Jonathan David Humpherys, Weatogue, CT (US); Jacqueline E. Teach, Enfield, CT (US); Mark DiPaola, Middletown, CT (US); Emma C. Walker, West Winfield, NY (US); Samuel Asante Buahin, Charlotte, NC (US); Kunal Prakash Chaudhari, Charlotte, NC (US)

(21) Appl. No.: 19/081,663

(22) Filed: Mar. 17, 2025

(51) Int. Cl. G06V 30/12; G06V 30/148

(52) U.S. Cl. CPC G06V 30/12; G06V 30/153

(57) ABSTRACT

According to some embodiments, systems and methods are provided including receiving, from a user of a remote device via a distributed communication network, an indication of a selected data file; retrieving, from an incoming unstructured data content file data store, information about the selected data file; based on the retrieved information, automatically validating at least some of the associated optical character recognition information, natural language processing information, and video content analysis information for the selected data file; and automatically assigning a workflow to the selected data file in accordance with the validated information and logic. Numerous other aspects are provided.

### BACKGROUND

In some cases, an enterprise may collect and process a variety of data in different forms and from different sources. For example, an insurer may process thousands of incoming medical documents (e.g., doctor reports, hospital records, etc.), images and videos (e.g., images and videos associated with claims, requests for quotes, etc.), documents associated with quotes/issues, service endorsements, policy renewals, audits, payroll, claims, etc. on a daily basis or several millions of documents, images and videos per year. Typically, a user manually reviews each document, image and video and enters the relevant information into an enterprise system. For example, a first name, last name and driver's license number may be located by the user and entered into an enterprise database. The enterprise database may then be used to further process the information (e.g., by assigning a workflow, etc.). Such an approach, however, can be a time consuming and error prone process-especially when a substantial number of images, videos and documents and/or various types of relevant information are involved.

Systems and methods for improvements in processes relating to the management of documents, images and videos, while avoiding unnecessary burdens on computer processing resource utilization, would be desirable.

### SUMMARY

According to some embodiments, systems, methods, apparatus, computer program code and means may provide ways to facilitate management of images, videos and documents in a way that provides fast and useful results and that allows for flexibility and effectiveness when implementing those results.

For example, some embodiments are directed to a system an incoming unstructured data content file data store containing electronic records, each record including an unstructured data file identifier and an unstructured data file along with associated optical character recognition information, natural language processing information and video content analysis information generated by a cloud-based computing environment; an incoming unstructured data content file tool, coupled to the incoming unstructured data content file data store, including: a computer processor for executing program instructions; and a memory, coupled to the computer processor, storing program instructions that, when executed by the computer processor, cause the incoming unstructured data content file tool to: receive, from a user of a remote device via a distributed communication network, an indication of a selected data file; retrieve, from the incoming unstructured data content file data store, information about the selected data file; based on the retrieved information, automatically validate at least some of the associated optical character recognition information, natural language processing information, and video content analysis information for the selected data file; and automatically assign a workflow to the selected data file in accordance with the validated information and logic.

Some embodiments are directed to a method including receiving, by a computer processor of an incoming unstructured data content file tool from a user of a remote user device via a distributed communication network, receiving, from a user of a remote device via a distributed communication network, an indication of a selected data file; retrieving, from an incoming unstructured data content file data store, information about the selected data file; based on the retrieved information, automatically validating at least some of the associated optical character recognition information, natural language processing information, and video content analysis information for the selected data file; and automatically assigning a workflow to the selected data file in accordance with the validated information and logic.

In some embodiments, a communication device associated with the incoming unstructured data content file tool exchanges information with remote devices in connection with an interactive graphical interface. The information may be exchanged, for example, via public and/or proprietary communication networks.

A technical effect of some embodiments of the invention is an improved and computerized way to accurately and automatically input unstructured data in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system according to some embodiments of the present invention.

FIG. 2 illustrates a method according to some embodiments of the present invention.

FIG. 3 is a high level flow according to some embodiments of the present invention.

FIG. 4 is a user interface display according to some embodiments of the present invention.

FIG. 5 is a user interface display with a pop-up window according to some embodiments of the present invention.

FIG. 6 is a user interface display according to some embodiments of the present invention.

FIG. 7A is an operator or administrator display according to some embodiments of the present invention.

FIG. 7B is an operator or administrator display according to some embodiments of the present invention.

FIG. 8 is a more detailed system architecture according to some embodiments of the present invention.

FIG. 9 is a block diagram of an apparatus or platform according to some embodiments of the present invention.

FIG. 10 illustrates a handheld tablet according to some embodiments of the present invention.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data availability, consistency and analytics associated with text-based documents, image documents, images and video. The present invention is directed to more than merely a computer implementation of a routine or conventional activity previously known in the industry as it provides a specific advancement in the area of electronic record availability, consistency and analysis by providing improvements in the operation of a computer system that uses machine learning and/or predictive models to ensure data quality. The present invention provides improvement beyond a mere generic computer implementation as it involves the novel ordered combination of system elements and processes to provide improvements in the speed at which such data can be made available and consistent with results. Some embodiments of the present invention are directed to a system adapted to automatically validate unstructured data information, analyze electronic records, aggregate data from multiple sources including third-party data sources, social media, etc., and determine workflows, etc. Moreover, communication links and messages may be automatically established (e.g., to provide unstructured data reports, and alerts to appropriate parties within an organization), aggregated, formatted, exchanged, etc. to improve network performance (e.g., by reducing an amount of network messaging bandwidth and/or storage required to support incoming image document collection, analysis and distribution).

As described above, an enterprise may collect and process a variety of data in different forms (e.g., text documents, images, photographs, audio files, and videos, etc.) and from different sources. This data may be unstructured data. Unstructured data is information that does not follow a pre-defined format or structure, making it difficult to store and analyze using traditional database methods. The unstructured data lacks a consistent schema and is often stored in a free-form manner, unlike structured data which fits neatly into organized tables or fields. Typically, a user manually reviews each document, image and video and enters the relevant information into tables or fields of an enterprise system. As a non-exhaustive example, a user may want to add multiple drivers to an enterprise system. To do so, the user manually reviews at least one of: a submitted form for each driver and each driver's license, and then manually inputs the first name, last name, and license number into an enterprise system for each driver. This manual process is time consuming and error prone.

To address these problems, the incoming unstructured data content file tool provided by embodiments automatically and dynamically executes the steps for receiving an unstructured data file (e.g., text-based, image, audio, video, etc.) and retrieving information about the file. The incoming unstructured data content file tool then automatically validates information extracted from the file via at least one of optical character recognition, natural language processing, and video content analysis. The validated data may be accepted and/or corrected by the user. The incoming unstructured data content file tool then automatically assigns a workflow to the file in accordance with the request and the validated information. For example, in the case of the driver's license, the tool may access a third-party (e.g., Department of Motor Vehicles (DMV)) to validate the driver's licenses. The tool may automatically assign an eligibility workflow for the validated driver's licenses (e.g., analyzing driving record, credit rating, etc.). As part of the workflow, the data may automatically populate a template or other form.

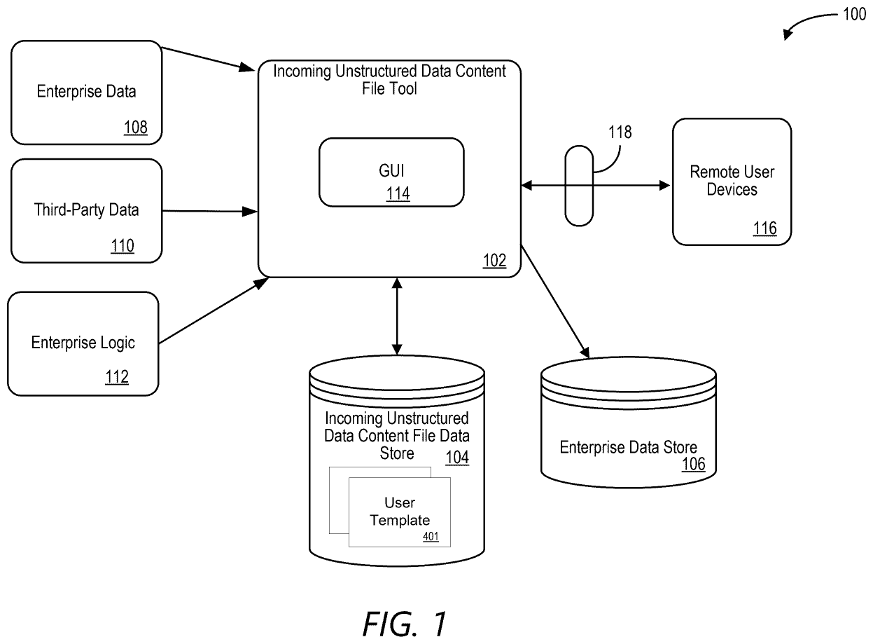

FIG. 1 is a high-level block diagram of a system 100 according to some embodiments of the present invention. In particular, the system 100 includes an incoming unstructured data content file tool 102 that may access information in an incoming unstructured data content file data store 104 (e.g., storing a set of electronic records representing files (e.g., text-based documents, audio files, image files, video files, etc.) each record including, for example, file content data, one or more file identifiers, cloud-generated results, etc.) and/or an enterprise data store 106 (e.g., to store automatically validated information). The incoming unstructured data content file tool 102 may also retrieve information from other data stores or other sources (e.g., enterprise data 108 about existing insurance policies and insurance claims, third-party data 110 such as police reports, DMV records, social media, etc., and enterprise logic 112 defining how files should be routed or evaluated) in connection with a Graphical User Interface (“GUI”) 114 and apply machine learning or artificial intelligence algorithms and/or models to the electronic records. The incoming unstructured data content file tool 102 may also exchange information with remote user devices 116 (e.g., via communication port 118 that might include a firewall). According to some embodiments, GUI 114 of the incoming unstructured data content file tool 102 may facilitate the display of information associated with incoming files via one or more remote computers (e.g., to enable a manual review of validated data, a manual review of automatically generated and populated templates, establish (in some cases automatically) a communication link with another user, claim analyst or handler, and/or initiate an automatically assigned workflow) and/or the remote user devices 116. For example, the remote user devices 116 may receive updated information (e.g., a new text-based document) from the incoming unstructured data content file tool 102. Based on the updated information, a user may review the data from the incoming unstructured data content file data store 104 and make informed decisions about document management. Note that the incoming unstructured data content file tool 102 and/or any of the other devices and methods described herein may be associated with a cloud-based environment and/or a third-party, such as a vendor that performs a service for an enterprise.

The incoming unstructured data content file tool 102 and/or the other elements of the system 100 may be, for example, associated with a Personal Computer (“PC”), laptop computer, tablet, smartphone, an enterprise server, a server farm, and/or a database or similar storage devices. According to some embodiments, an “automated” incoming unstructured data content file tool 102 (and/or other elements of the system 100) may facilitate the automated access and/or update of electronic records in the incoming unstructured data content file data store 104 or enterprise data store 106. As used herein, the term “automated” may refer to, for example, actions that can be performed with little (or no) intervention by a human.

As used herein, devices, including those associated with the incoming unstructured data content file tool 102 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The incoming unstructured data content file tool 102 may store information into and/or retrieve information from the incoming unstructured data content file data store 104. The incoming unstructured data content file data store 104 might, for example, store electronic records representing a plurality of incoming files, each electronic record having a file identifier and a data content file. The data content file is a file that contains data as images, audio, video, text documents or other data types. It is noted that while the data in the data content file is in a specific format, it is unstructured in that it is not in a structure which fits neatly into organized tables or fields, making it more difficult to use by the enterprise without manually extracting the data needed for input to the organized tables and fields of the enterprise. The incoming unstructured data content file data store 104 may also contain information about prior and current interactions with entities, including those associated with remote devices 116. The incoming unstructured data content file tool data store 104 may be locally stored or reside remote from the incoming unstructured data content file tool 102. As will be described further below, the unstructured data file data store 104 may be used by the unstructured data file tool 102 in connection with an interactive user interface to provide information about file management. Although a single incoming unstructured data content file tool 102 is shown in FIG. 1, any number of such devices may be included. Moreover, various devices described herein may be combined according to embodiments of the present invention.

Note that the system 100 of FIG. 1 is provided only as an example, and embodiments may be associated with additional elements or components. According to some embodiments, the elements of the system 100 automatically transmit information associated with an interactive user interface display over a distributed communication network.

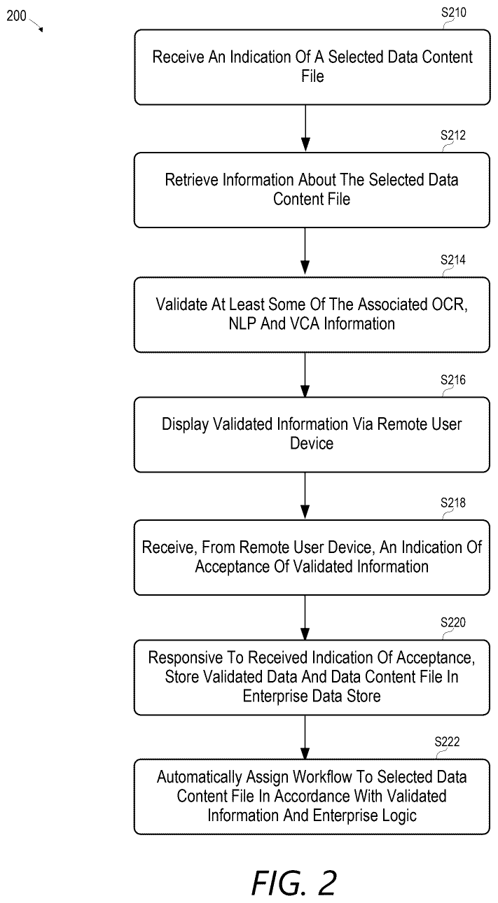

FIG. 2 illustrates a process 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

FIG. 2 comprises a flow diagram of a process 200 to execute the incoming unstructured data content file tool 102 according to some embodiments. Process 200 and other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Initially, at S210, a computer processor of an incoming unstructured data content file tool receives, for a user of a remote user device via a distributed communication network, an indication of a selected data content file. The selected data content file is related to a request (e.g., a request to add new drivers to an insurance policy). For example, a user may select a particular data content file from a list of available data content files, search for a particular data content file, etc. The data content file might comprise, for example, document file, a Portable Document Format (“PDF”) file, a bitmap (“BMP”) image, a Waveform Audio (WAV) file, an MP3, MP4, AVI, WMV, WebM, etc. The data content files may comprise, for example, driver's licenses, images or a video of small business equipment, bills, paperwork, etc. that are received via electronic mail, a facsimile machine, a scanner device, etc.

Then, at S212, the system may retrieve, from an incoming unstructured data content file data store 104, information about the selected data content file. The incoming unstructured data content file data store 104 may, according to some embodiments, contain electronic records, each record including a data content file identifier and a data content file along with associated optical character recognition (“OCR”) information, natural language processing (“NLP”) information and video content analysis (“VCA”) information generated by a cloud-based computing environment for the enterprise. OCR, NLP and VCA are all types of artificial intelligence that use machine learning and neural networks in their analysis. Pursuant to embodiments, the OCR, NLP and VCA may be generated upon receipt of the file —automatically or via manual interaction and then that information is stored in the incoming unstructured data content file data store 104.

As used herein, the phrase “optical character recognition” may refer to, for example, the conversion of images of typed (e.g., including various fonts), handwritten or printed text into machine-encoded text (e.g., an ASCII text (“TXT”) file). Moreover, the phrase “natural language processing” may refer to, for example, a process to analyze large amounts of natural language data to understand the contents of text in spreadsheets, images, etc. including contextual nuances, to accurately extract information and insights contained in the images. Natural language processing may also be used, in embodiments, on a video after text content is extracted from the video through automatic speech recognition (ASR) or other suitable process to convert the audio into text (e.g., text can be analyzed using Natural Language Processing). The video is first processed to extract the audio track, which is then fed into an ASR model to generate a text transcript. The generated text, and text extracted from spreadsheets, documents and images is analyzed using NLP techniques like sentiment analysis, topic modeling, named entity recognition, etc., to extract meaning and insights from the video content, spreadsheets, documents and images. Further, the phrase “video content analysis” may refer to, for example, a machine learning process to extract information from videos and interpret video content. Video content analysis may include object detection (identifies objects, people, and other entities in a video), text detection (extracts text from videos in any language), face detection (identifies faces in a video), sentiment analysis (analyzes the emotional tone of a video to understand customer opinions), and template matching (compares a video to a template). According to some embodiments, the associated optical character recognition information, natural language processing information and video content analysis information is represented by a JavaScript Object Notation (“JSON”) file.

Based on the retrieved information, at S214 the incoming unstructured data content file tool 102 may automatically validate at least some of the associated optical character recognition, natural language processing information and video content analysis information for the selected data content file. Validation may include, but is not limited to, extracting data from the data content file and validating the extracted data to ensure accuracy (no incorrect data), structure (e.g., the number of columns in a spreadsheet, for example, are correct) and completeness of data (e.g., there is no missing data). Validation may include cross referencing data with one or more other data sources/inputs. Additionally, validation may ensure the types of data (e.g., format) or input values are appropriate (e.g., no incorrect formatting). In one or more embodiments, validation may also include confirming there is no duplicate data compared to data already stored in the system.

As a non-exhaustive example, in the case of a spreadsheet with people's first name and last name, in a first spreadsheet file, the first and last names are in one column, and in another spreadsheet file, the first and last name are in two columns. Here, the incoming unstructured data content file tool 102 analyzes both the spreadsheets and validates, using a machine learning model or other artificial intelligence model, that both files contain the first and last names.

As another non-exhaustive example, in the case of a spreadsheet including first name, last name and license numbers, the incoming unstructured data content file tool 102 extracts, using associated OCR and NPL processing, the first name, last name and license numbers, and then contacts a secondary data source (e.g., a third party such as the DMV) to ensure the license number associated with that first name and last name is accurate. Similarly, in the case of an image of a driver's license, the incoming unstructured data content file tool 102 extracts, using associated OCR and NPL processing, first name, last name and license number from the image and contacts the DMV to ensure the license number associated with that first name and last name is accurate. As another non-exhaustive example of using third-party data, the incoming unstructured data content file tool 102 may access Construction, Occupancy, Protection, Exposure (COPE) data from a specialized third-party data provider that compiles property information, including construction details, occupancy type, fire protection systems and surrounding risks.

As yet another example of validation using image analysis, in a case of obtaining an insurance quote, a construction enterprise may take a picture of their backhoe. The incoming unstructured data content file tool 102 uses artificial intelligence to ensure the backhoe is a backhoe (e.g., object recognition), and may determine information about the backhoe from further analysis of the image. For example, the incoming unstructured data content file tool 102 may identify a label on the backhoe and determine and/or confirm the make, model, and manufacturer of the backhoe. In another example, instead of one image, there are a series of images of tools. The incoming unstructured data content file tool 102 uses artificial intelligence to create a scheduled item list, determining the value of each item through internet comparison, for example.

As still yet another non-exhaustive example of validation, the incoming unstructured data content file tool 102 uses artificial intelligence sentiment/image analysis and supplemental data in social media web crawling. Social media web crawling refers to the process of using automated software to navigate social media platforms and extract data like posts, comments, user profiles and hashtags. Through “crawling”, the incoming unstructured data content file tool 102 may gather information for validation analysis. For example, the incoming unstructured data content file tool 102 may determine a subcontractor class based on a name/address of the person. As another example, consider a restaurant applying for insurance. The restaurant may submit certain information and have certain information on their website. However, through social media crawling, the incoming unstructured data content file tool 102 may determine big events occur in the parking lot, which may affect the determination of risk.

Pursuant to embodiments, the incoming unstructured data content file tool 102 populates one or more templates and/or databases with the validated data.

Note that according to some embodiments, the validated information is further processed by Machine Learning (“ML”) models (e.g., trained using text, audio and image data), an automated data analysis algorithm, and/or a symbolic rules model (e.g., explicitly defined by an expert).

At S216, the validated information may be displayed via the remote user device. In one or more embodiments, the templates populated with the validated data are displayed via the remote user device. The validated information may be displayed in other formats via the remote user device. The incoming unstructured data content file tool 102 may receive, from the remote user device, an indication of acceptance of the validated information at S218.

Responsive to the received indication of acceptance, the system may store the validated information and data content file in the enterprise data store 106 at S220. According to some embodiments, the indication of acceptance of the validated information includes in some cases at least one adjustment to the validated information (e.g., a license number may be corrected). In other cases, no adjustment to the validated information might be made.

At S222, the system may automatically assign a workflow for the selected data content file in accordance with the validated information and enterprise logic 112. For example, the incoming data content file may comprise a spreadsheet (e.g., Microsoft's Excel®) file including first names, last name, and driver license numbers, the enterprise might be an insurer, and the assigned workflow may be associated with an insurance eligibility process. Pursuant to some embodiments, assignment of the workflow may initiate execution of the workflow. The enterprise logic 112 may be associated with license class and status, expiration date, driver violation points, suspensions and revocations, convictions and bail forfeitures and accidents. Note that eligibility processing may be associated with automobile insurance. Other workflows include, but are not limited to, workflows for insurance quotes/issue, service endorsements, policy renewal, audit, payroll data, claims, management, etc. The insurance processing may be associated with workers'compensation insurance, group benefit insurance, short term disability insurance, long term disability insurance, automobile insurance, general liability insurance, etc.

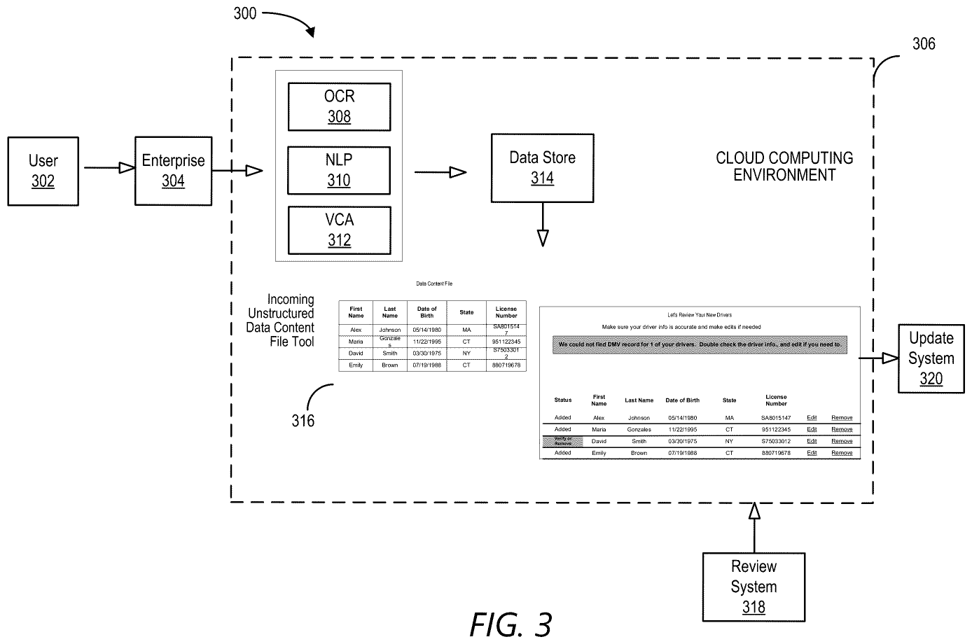

FIG. 3 is a high level flow 300 in accordance with some embodiments. A user 302 may upload a data content file to an enterprise 304 (e.g., insurer) that forwards the data content file to a cloud computing environment 306 (e.g., an AMAZON® Web Services (“AWS”) computing environment). The cloud computing environment 306 may execute Optical Character Recognition (“OCR”) 308, Natural Language Processing (“NLP”) 310 and Video Content Analysis (“VCA”) 312 to create data content file data in the data store 314 along with the data content file. Information in the data store 314 can then be displayed via an incoming unstructured data content file tool 316 to be reviewed by a user directly or via a review system 318. Embodiments may be associated with any type of user (e.g., an employee, a client, etc.). When approved, the data content file data may be used to notify or update a system 320 (e.g., to determine and/or execute an appropriate workflow for the data content file).

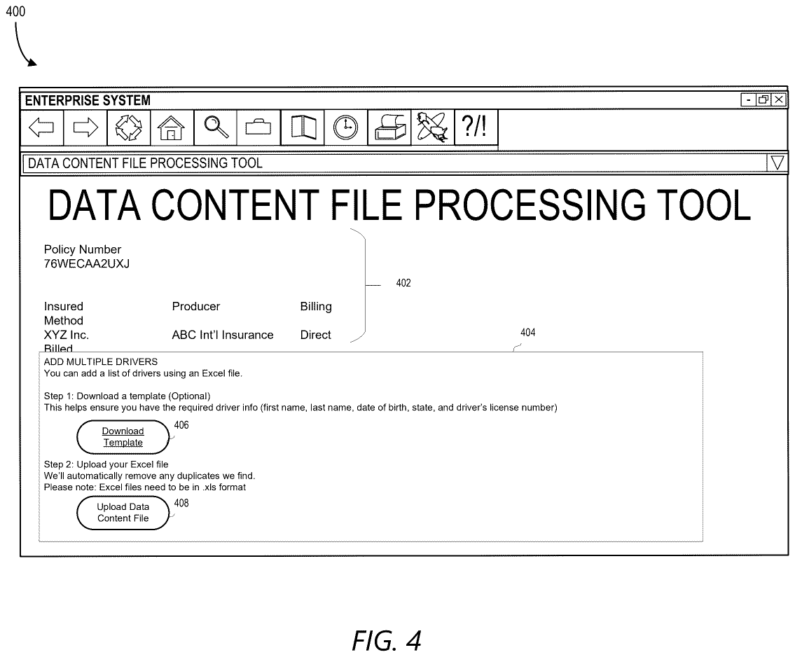

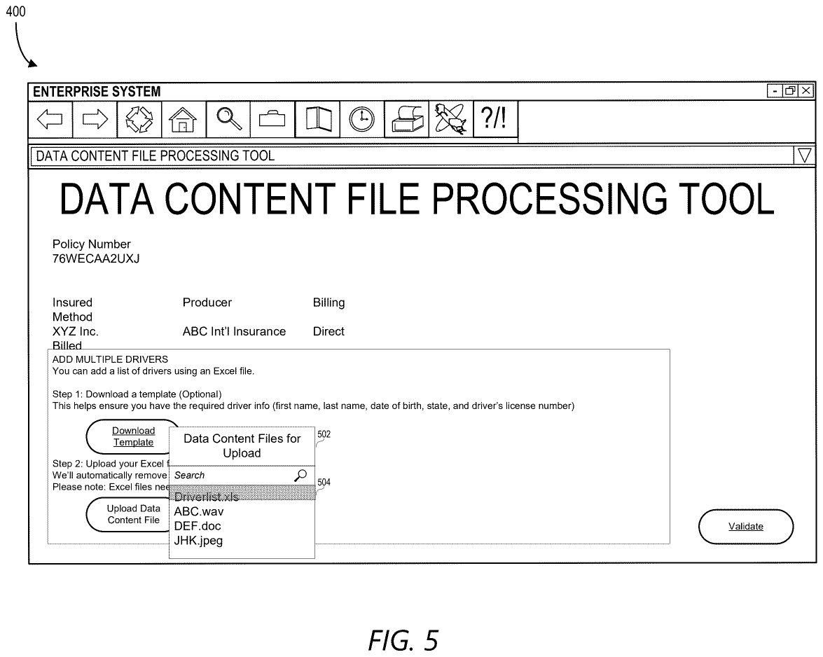

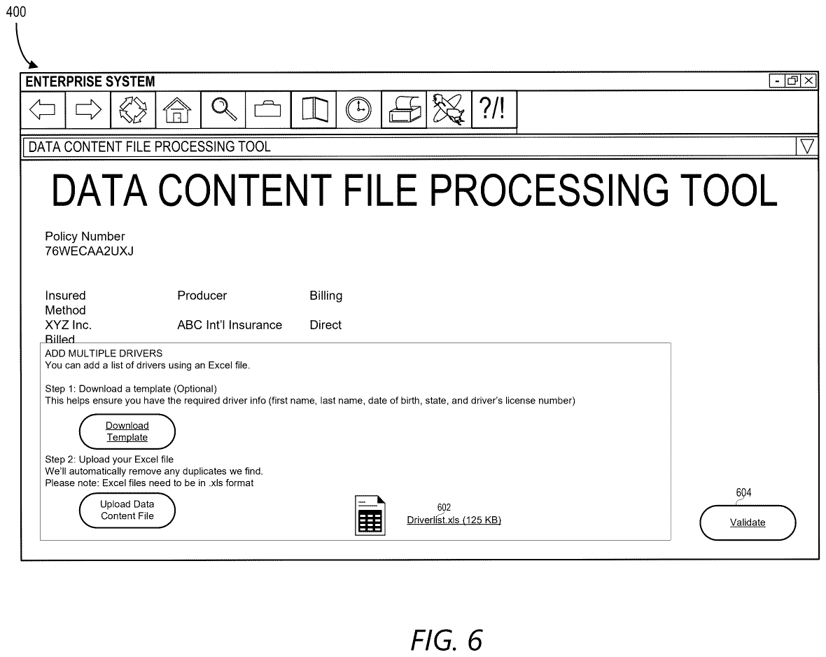

For example, FIG. 4 is a data content file welcome display 400 for the incoming unstructured data content file processing tool. The display 400 includes identifying information 402 and a data content file section 404. Here, the identifying information 402 includes the insured, policy number, producer, billing method. Here the identifying information is for a given policy number. The data content file section 404 includes a download template icon 406 and an upload data content file icon 408. Pursuant to embodiments, the incoming unstructured data content file tool may include one or more user templates 401 (FIG. 1). The user templates 401 may indicate the data required for a given request. Continuing with the non-exhaustive example, here the request is for adding drivers to an insurance policy. Other request examples are replacing equipment, updating records, etc. Selection of the download template icon 406 results in the generation of a stored template. The appropriate data may then be manually entered in the user template and the template saved with entered data. Selection of the upload data content file icon 408 provides a pop-up window 502 (FIG. 5) including one or more selectable data content files. Pursuant to embodiments, a plurality of data files may be selected (e.g., multiple drivers license images). After selection of the data content file (here indicated by shading 504), a file link 602 (FIG. 6) and a validate icon 604 (FIG. 6) are populated on the display 400. It is noted that the use of a user template is not required, and a data content file that is not based on a user template may be uploaded via selection of the upload data content file icon 408. Selection of the file link 602 opens the file for further review of the file content. Selection of the validate icon 604 initiates validation of the data content file as described above with respect to S214 of FIG. 2.

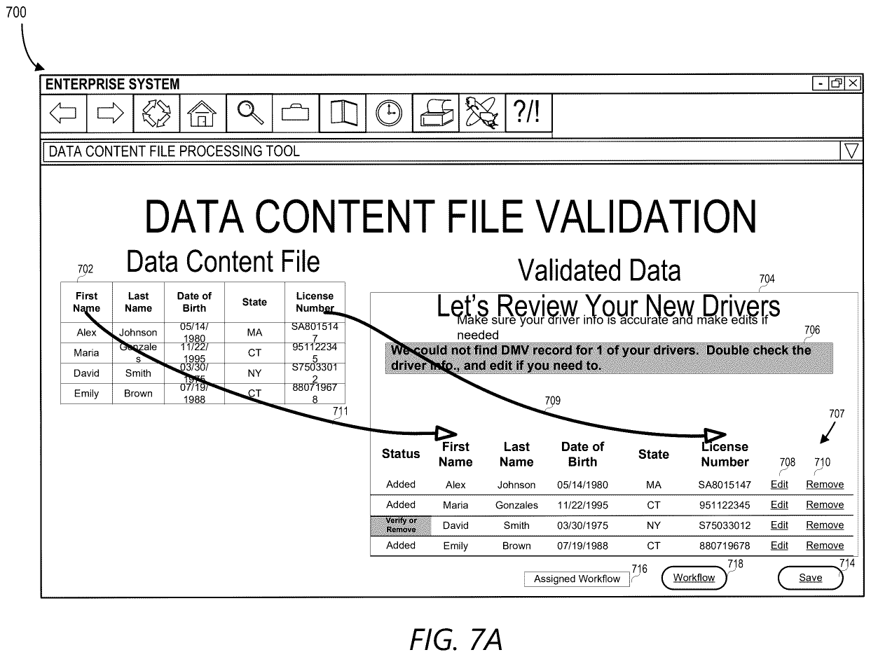

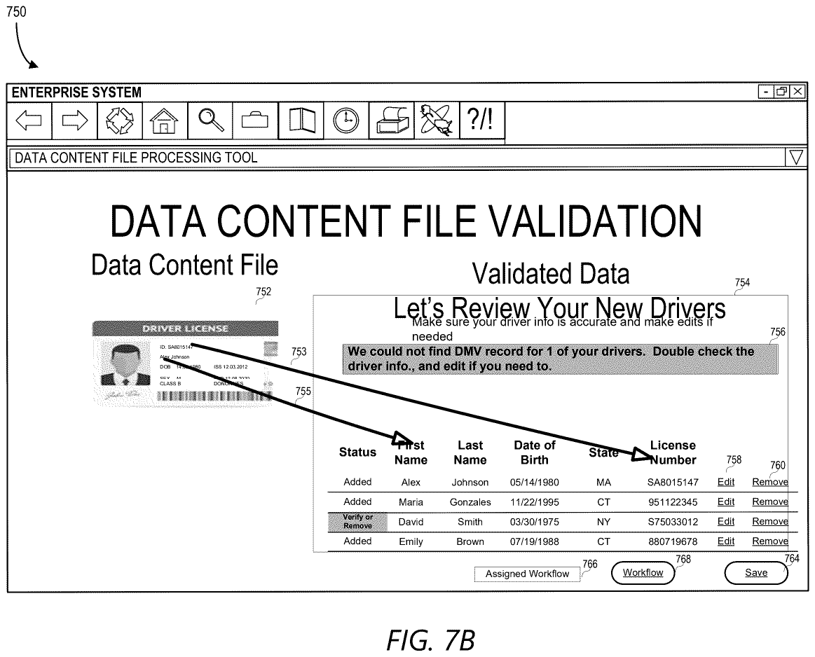

FIG. 7A is a data content validation display 700 according to some embodiments. The display 700 includes a rendering of the data of the original data content file 702 received by the system (e.g., a rendering of the file). Moreover, automatically generated validation 704 based on cloud-generated OCR, NLP and AVC data is also provided on the display 700. The validation 704 may include alerts 706 (e.g., when the system detects that information is missing or requires specific action by the user) and population of pre-defined data fields in a validation template 707 as illustrated by arrows 709, 711 in FIG. 7A. The arrows 709, 711 show the mapping of at least some of the associated OCR, NLP and AVC data for the selected data file to pre-defined data fields. A user may then adjust the validation 704 as appropriate via selection of an edit icon 708 and a remove icon 710 (e.g., via a touchscreen, keyboard, and/or computer mouse pointer) and select a “Save” icon 714 when the information is correct. The data content validation display 700 also includes a workflow assignment indicator 716. As described above, the incoming unstructured data content file tool automatically assigns a workflow to the file in accordance with the request and the validated information. In one or more embodiments, the workflow is assigned in response to selection of the “Save” icon 714. The data content validation display 700 further includes an assigned “Workflow” icon 718. Selection of the “Workflow” icon 718 results in execution of the assigned workflow.

FIG. 7B is a data content validation display 750 according to some embodiments. The display 750 includes a rendering of the data of the original data content file 752 received by the system (e.g., here a rendering of an image of a driver's license). Like the display 700 of FIG. 7A, here, the display 750 provides automatically generated validation 754 based on cloud-generated OCR, NLP and AVC data. The validation 754 may include alerts 756 (e.g., when the system detects that information is missing or requires specific action by the user) and population of pre-defined data fields in a validation template as illustrated by arrows 753, 755 in FIG. 7B. The arrows 753, 755 show the mapping of at least some of the associated OCR, NLP and AVC data for the selected data file to pre-defined data fields. A user may then adjust the validation 754 as appropriate via selection of an edit icon 758 and a remove icon 760 (e.g., via a touchscreen, keyboard, and/or computer mouse pointer) and select a “Save” icon 764 when the information is correct. The data content validation display 750 also a workflow assignment indicator 766. As described above, the incoming unstructured data content file tool automatically assigns a workflow to the file in accordance with the request and the validated information. In one or more embodiments, the workflow is assigned in response to selection of the “Save” icon 764. The data content validation display 750 further includes an assigned “Workflow” icon 768. Selection of the “Workflow” icon 768 results in execution of the assigned workflow.

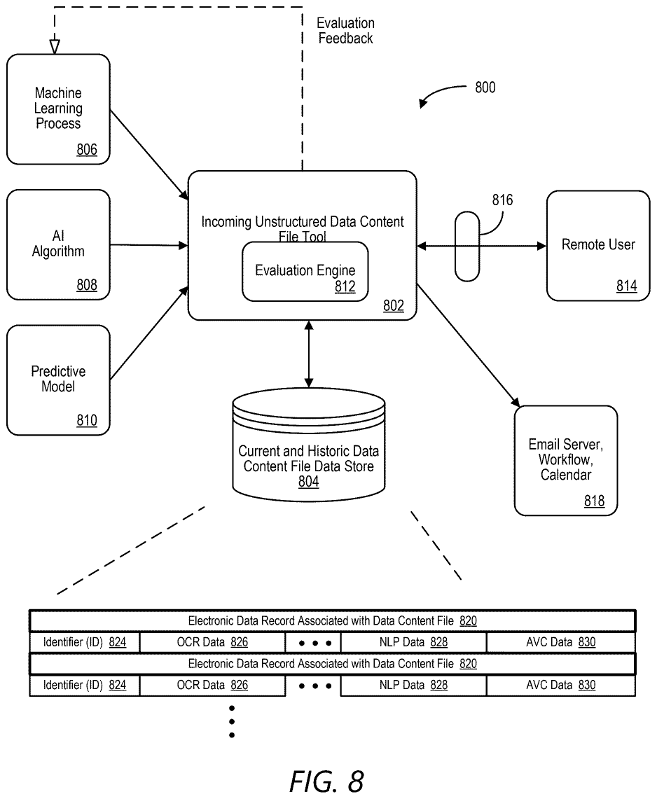

FIG. 8 is a more detailed high-level block diagram of a system 800 in accordance with some embodiments. As before, the system 800 includes an incoming unstructured data content file tool 802 that may access information in a current and historic data content file data store 804. The incoming unstructured data content file tool 802 may also retrieve information from a machine learning process 806, an Artificial Intelligence (“AI”) algorithm 808, and/or predictive models 810 in connection with an evaluation engine 812. The incoming unstructured data content file tool 802 may also exchange information with a remote user 814 (e.g., via communication port 816 that might include a firewall) to enable a manual review of automatically generated validation data. According to some embodiments, evaluation feedback is provided to the machine learning process 806 (e.g., so that at least one of an OCR, NLP and AVC process or workflow assignment may be automatically improved). The incoming unstructured data content file tool 802 may also transmit information directly to an email server (or postal mail server), a workflow application, and/or a calendar application 818 to facilitate data content file management.

The incoming unstructured data content file tool 802 may store information into and/or retrieve information from the current and historic data content file data store 804. The current and historic data content file data store 804 may, for example, store electronic records 820 representing a plurality of data content files, each electronic record having a set of attribute values including a data content file identifier 824, at least one of OCR data 826, NLP data 828, and AVC data 830, etc. According to some embodiments, the system 800 may also provide a dashboard view of data content file management information.

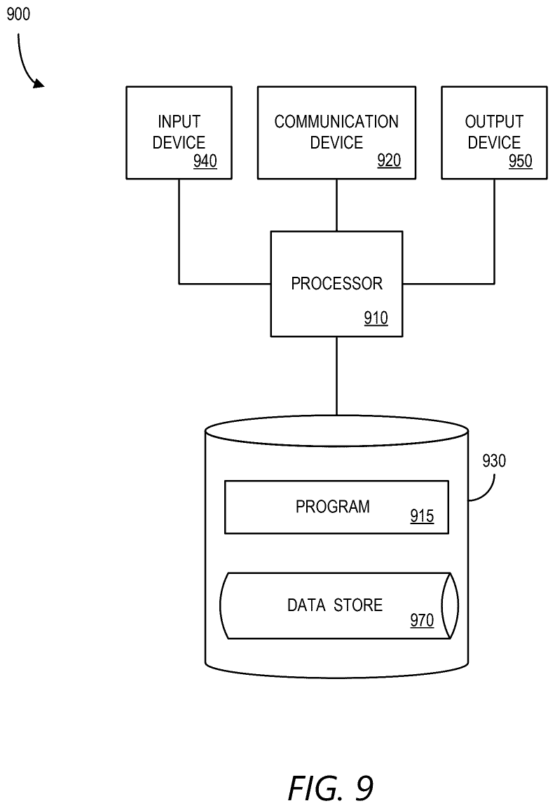

The embodiments described herein may be implemented using any number of different hardware configurations. For example, FIG. 9 illustrates an apparatus 900 that may be, for example, associated with system 100 described with respect to FIG. 1. The apparatus 900 comprises a processor 910, such as one or more commercially available Central Processing Units (“CPUs”) in the form of one-chip microprocessors, coupled to a communication device 920 configured to communicate via a communication network (not shown in FIG. 9). The communication device 920 may be used to communicate, for example, with one or more remote third-party business or economic platforms, administrator computers, insurance agents, and/or communication devices (e.g., PCs and smartphones). Note that communications exchanged via the communication device 920 may utilize security features, such as those between a public internet user and an internal network of an insurance company and/or enterprise. The security features might be associated with, for example, web servers, firewalls, and/or PCI infrastructure. The apparatus 900 further includes an input device 940 (e.g., a mouse and/or keyboard to enter information about data content files, etc.) and an output device 950 (e.g., to output validated data, etc.).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 915 and/or an application for controlling the processor 910. The processor 910 performs instructions of the program 915, and thereby operates in accordance with any of the embodiments described herein. For example, the processor 910 may receive a request for execution of a process including uploading a data content file, and based on the system tools, automatically validate the data in the data content file and assign (and in some cases execute) a workflow based thereon.

The program 915 may be stored in a compressed, uncompiled and/or encrypted format. The program 915 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

In some embodiments (such as shown in FIG. 9), the storage device 930 further includes a data store 970. Note that any database described herein is only an example, and additional and/or different information may be stored therein. Moreover, various databases might be split or combined in accordance with any of the embodiments described herein.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

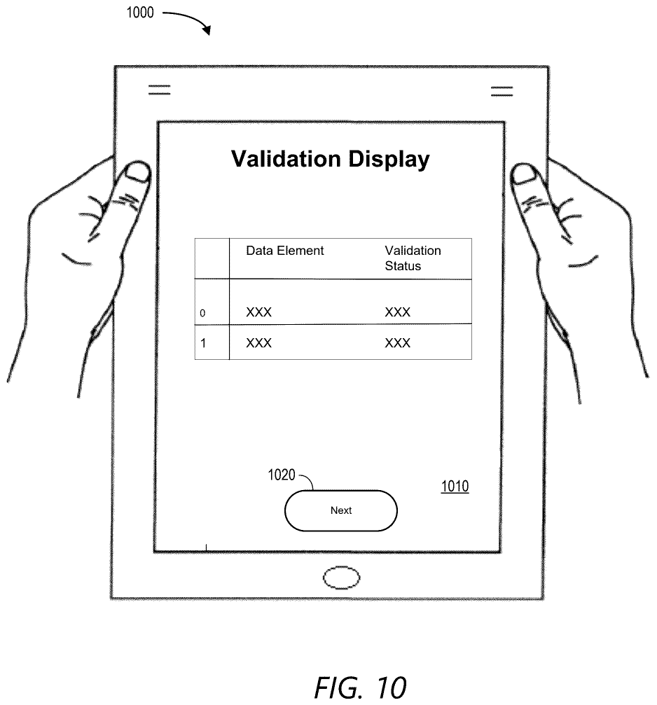

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities, embodiments may instead be associated with other types of businesses in addition to and/or instead of those described herein (e.g., financial institutions, universities, governmental departments, any enterprise migrating a lot of data). Similarly, although certain types of certain attributes were described in connection with some embodiments herein, other types of attributes may be used instead. Still further, the displays and devices illustrated herein are only provided as examples, and embodiments may be associated with any other types of user interfaces. For example, FIG. 10 illustrates a tablet computer 1000 with a Validation status display 1010 according to some embodiments. The display 1010 includes a table listing a data element and its validation status. Selection of the “Next” icon 1020 might result in transmission of a request to assign a workflow process to the validated data.

The present invention has been described in terms of several embodiments solely for the purpose of illustration. Persons skilled in the art will recognize from this description that the invention is not limited to the embodiments described but may be practiced with modifications and alterations limited only by the spirit and score of the appended claims.

What is claimed is:

1. A system comprising:
an incoming unstructured data content file data store containing electronic records, each record including an unstructured data file identifier and an unstructured data file along with associated optical character recognition information, natural language processing information and video content analysis information generated by a cloud-based computing environment;
an incoming unstructured data content file tool, coupled to the incoming unstructured data content file data store, including:
a computer processor for executing program instructions; and
a memory, coupled to the computer processor, storing program instructions that, when executed by the computer processor, cause the incoming unstructured data content file tool to:
receive, from a user of a remote device via a distributed communication network, an indication of a selected data file;
retrieve, from the incoming unstructured data content file data store, information about the selected data file;
based on the retrieved information, automatically validate at least some of the associated optical character recognition information, natural language processing information, and video content analysis information for the selected data file; and
automatically assign a workflow to the selected data file in accordance with the validated information and logic; and
a communication port coupled to the unstructured data file tool to facilitate a transmission of data with the remote user device to provide a graphical interactive user interface display via the distributed communication network, the graphical user interface display including an indication of the assigned workflow.

2. The system of claim 1, wherein validation further comprises causing the unstructured data file tool to:
map at least some of the associated optical character recognition information, natural language processing information, and video content analysis information for the selected data file to pre-defined data fields.

3. The system of claim 2, wherein validation of the mapped information further comprises causing the unstructured data file tool to identify at least one of: missing information and incorrect formatting.

4. The system of claim 1, wherein the automatic validation includes the unstructured data file tool accessing a secondary data source.

5. The system of claim 1, wherein the unstructured data file is one of: a spreadsheet file, a photograph, a document, a text, a video, and an audio file.

6. The system of claim 1, further cause the incoming unstructured data content file tool to:
receive, from the user of the remote device via the distributed communication network, an indication of a plurality of selected data files.

7. The system of claim 1, further comprising causing the unstructured data file tool to:
display the validated information via the remote user device;
receive, from the remote user device, an indication of acceptance of the validated information; and
responsive to the received indication of acceptance, stored the validated information and unstructured data file in an enterprise data store.

8. The system of claim 7, wherein the indication of acceptance of the validated information includes in some cases at least one adjustment to the validated information.

9. The system of claim 7, wherein the indication of acceptance of the validated information includes in some cases no adjustment to the validated information.

10. The system of claim 1, wherein the validated information is further processed by at least one of: a Machine Learning (“ML”) model, an automated data analysis algorithm, and a symbolic rules model.

11. The system of claim 1, wherein the associated optical character recognition and natural language processing information is represented by a JavaScript Object Notation (“JSON”) file.

12. A computer-implemented method comprising:
receiving, from a user of a remote device via a distributed communication network, an indication of a selected data file;
retrieving, from an incoming unstructured data content file data store, information about the selected data file;
based on the retrieved information, automatically validating at least some of associated optical character recognition information, natural language processing information, and video content analysis information for the selected data file; and
automatically assigning a workflow to the selected data file in accordance with the validated information and logic.

13. The method of claim 12, wherein validation further comprises: mapping at least some of the associated optical character recognition information, natural language processing information, and video content analysis information for the selected data file to pre-defined data fields.

14. The method of claim 13, wherein validation of the mapped information further comprises:
identifying at least one of: missing information and incorrect formatting.

15. The method of claim 12, further comprising:
displaying the validated information via the remote user device;
receiving, from the remote user device, an indication of acceptance of the validated information; and
responsive to the received indication of acceptance, storing the validated information and unstructured data file in an enterprise data store.

16. The method of claim 15, wherein the indication of acceptance of the validated information includes in some cases at least one adjustment to the validated information.

17. The method of claim 15, wherein the indication of acceptance of the validated information includes in some cases no adjustment to the validated information.

18. A non-transitory computer-readable medium storing instructions adapted to be executed by a computer processor to perform a method to facilitate image document processing for an enterprise, the method comprising:
receiving, from a user of a remote device via a distributed communication network, an indication of a selected data file;
retrieving, from an incoming unstructured data content file data store, information about the selected data file;
based on the retrieved information, automatically validating at least some of associated optical character recognition information, natural language processing information, and video content analysis information for the selected data file; and
automatically assigning a workflow to the selected data file in accordance with the validated information and logic.

19. The medium of claim 18, wherein validation further comprises: mapping at least some of the associated optical character recognition information, natural language processing information, and video content analysis information for the selected data file to pre-defined data fields.

20. The medium of claim 19, wherein validation of the mapped information further comprises:
identifying at least one of: missing information and incorrect formatting.
